(19) United States
(12) Patent Application Publication
(10) Pub. No.: US 2010/0077901 A1
(43) Pub. Date: Apr. 1, 2010

(54) METHOD, SYSTEM AND APPARATUS FOR A MULTIPLE FRET VARIABLE STRING CAPOTASTO

(75) Inventor: Samuel T. Artioli, Capitola, CA (US)

Correspondence Address: Keohane & D'Alessandro, 1881 Western Avenue, Suite 180, Albany, NY, 12203, US

(73) Assignee: Samuel T. Artioli, Capitola, CA (US)

(21) Appl. No.: 12/477,313

(22) Filed: Jun. 3, 2009

Related U.S. Application Data
(60) Provisional application No. 61/101,975, filed on Oct. 1, 2008.

(51) Int. Cl. G10D 3/04

(52) U.S. Cl. 84/318

(57) ABSTRACT

The present invention provides a multiple fret variable string capotasto implementing a trigger per string/fret location paradigm as well as triggers that adjust for the variable thickness and distance of the strings from the neck and/or device of the present invention.

### CROSS-REFERENCE TO RELATED APPLICATION

This application is related to and claims the benefit of co-pending application Ser. 61/101,975, entitled Method, System, and Apparatus for a multiple Fret Variable Capotasto, the entire contents of which are herein incorporated by reference.

### BACKGROUND OF THE INVENTION

1. Field of the Invention

The present invention relates to stringed instrument accessories and more specifically to a device that selectively applies tension to variable strings at multiple fret locations of a stringed instrument.

2. Description of Related Art

Numerous previous attempts have tried to allow the formation of chords over multiple frets through complex adjustments and attachments. All of which have the musician press one trigger to select multiple string/fret locations and in some cases require the removal of the device to change the location and configuration of pressure points.

### SUMMARY OF THE INVENTION

The present invention contemplates a variety of methods, systems, and/or devices/apparatuses for a Multiple Fret Variable String Capotasto. The Multiple Fret Variable String Capotasto will attach to the neck of a stringed instrument and utilize a trigger per string/fret paradigm allowing the musician to finger chords as they normally would on the neck of the instrument; giving the ability to create and hold any voicing possible over the fret span of the device and thus freeing the fingering hand to add to the voicing at other points along the neck that are not spanned by the device. The design also allows for the rapid changing of single notes or the entire voicing through the toggling of the triggers attached to the device residing at the desired string/fret positions.

Aspects of the invention provide a multiple fret variable string capotasto, comprising: a plurality of triggers arranged to span multiple frets for separate strings of a stringed instrument. The aspects further provide that:

The plurality of triggers can be adjustable;

The plurality of triggers can be arranged into a set of lines, each of the set of lines corresponding to a different one of the separate strings on the stringed instrument;

The set of lines can each comprise at least one trigger for each of the multiple frets;

The plurality of triggers can be arranged so that each of the separate strings has at least one separate trigger for each of the multiple frets;

The triggers being adjustable; and/or

The adjustability of the triggers is capable of accommodating variance(s) in thickness or position of any of the strings.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an envisioned embodiment of the invention for a six string guitar spanning four frets, implementing a side action tension method for attaching the invention to the neck of an instrument;

FIG. 2 is an exploded view of FIG. 1;

FIG. 3 is a cross sectional view focusing on an envisioned embodiment of a triggering mechanism in an uncompressed state;

FIG. 4 is a cross sectional view focusing on an envisioned embodiment of a triggering mechanism in a compressed state;

FIG. 5 illustrates an envisioned embodiment of the invention for a six string guitar spanning four frets, implementing a padding and/or Velcro system to attach the invention to the neck of an instrument;

FIG. 6 is a front view of FIG. 5, further illustrating the pad and/or Velcro system, as well as detailing the Angled Mounting System; and

FIG. 7 illustrates an envisioned embodiment of the invention for a six string guitar spanning four frets, implementing electric triggers and programmable buttons.

The drawings are not necessarily to scale. The drawings are merely schematic representations, not intended to portray specific parameters of the invention. The drawings are intended to depict only typical embodiments of the invention, and therefore should not be considered as limiting the scope of the invention. When used, like numbering represents like elements.

### DETAILED DESCRIPTION OF THE INVENTION

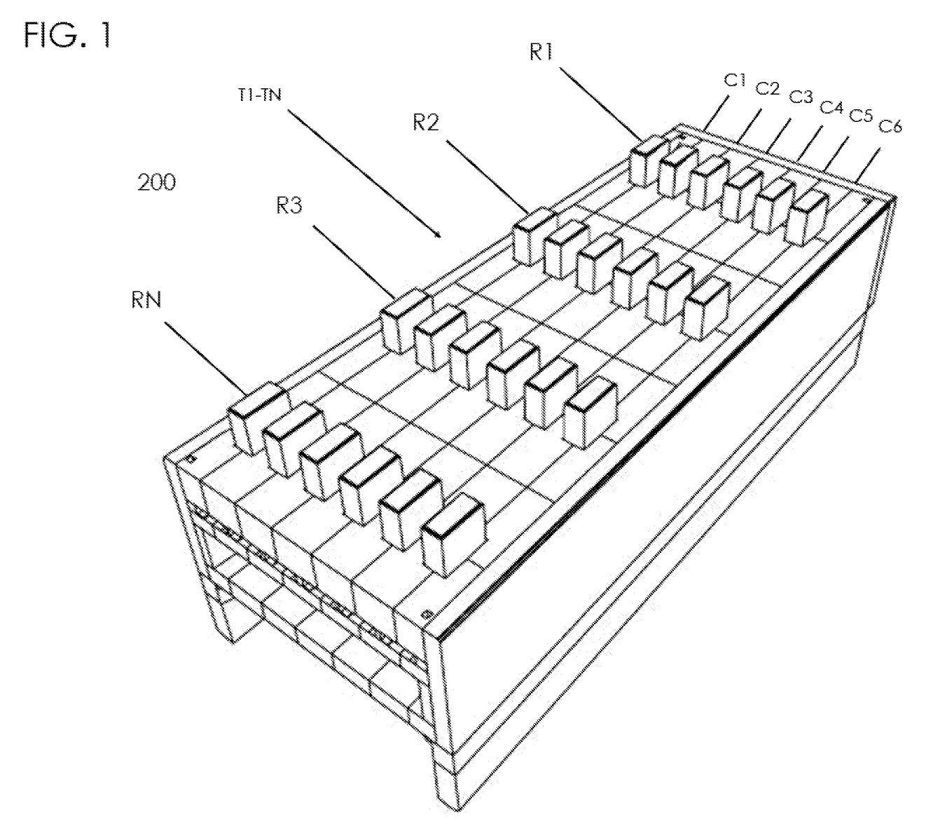

The intent of this device is to allow a musician to selectively apply tension to variable strings at multiple fret locations of a stringed instrument. This will enable the musician to change the voicing of the instrument using the device while freeing up their fingering hand to create more complex voicings. The device is also designed to allow for rapid changing of the voicing through the toggling of the triggers attached to the device. Among other ways, this device is separated from the previous art in that it retains a trigger per string/fret location paradigm. The triggers for this device are situated such that any fret position of a string encompassed by the device can be depressed based on the desire of the musician without the need to remove the device or interrupt a performance. FIG. 1 shows an envisioned embodiment of the trigger per string/fret paradigm of capotasto (200) created for a six string guitar spanning four frets. This structure allows the musician to finger chords as they normally would on the device and then to free their fingering hand to embellish on the voicing. This device (200) takes into account the design of triggers that will adjust for the variable thickness and distance of the strings. The design of this device will be easy to mass produce. The teachings recited herein can be applied to all triggers whether implemented electrically or mechanically.

Specifically, FIG. 1 illustrates one envisioned embodiment of the invention for a six string guitar spanning four frets. As shown, multiple triggers are arranged in a column-row or matrix format. Specifically, triggers T1-TN are arranged in lines or columns that are positioned adjacent one another. As depicted in this example, there are six columns C1-CN and four rows R1-RN. Each column or line C1-CN corresponds to a separate string on a stringed instrument, while each row corresponds to a separate fret. Therefore, under the arrangement of FIG. 1, each string would have triggers that span four frets (e.g., each string has a separate trigger for each fret). It should be understood that the invention is not limited to this specific configuration and/or quantity of rows and triggers. This arrangement can vary based on the type of stringed instrument and/or quantity of strings or frets present. In addition, the quantity of triggers per string and fret need not be limited by what is shown. There can be more (e.g., 5) or fewer (e.g., 0) triggers per string, and as well as more (e.g., 2) or fewer (e.g., 0) triggers per fret.

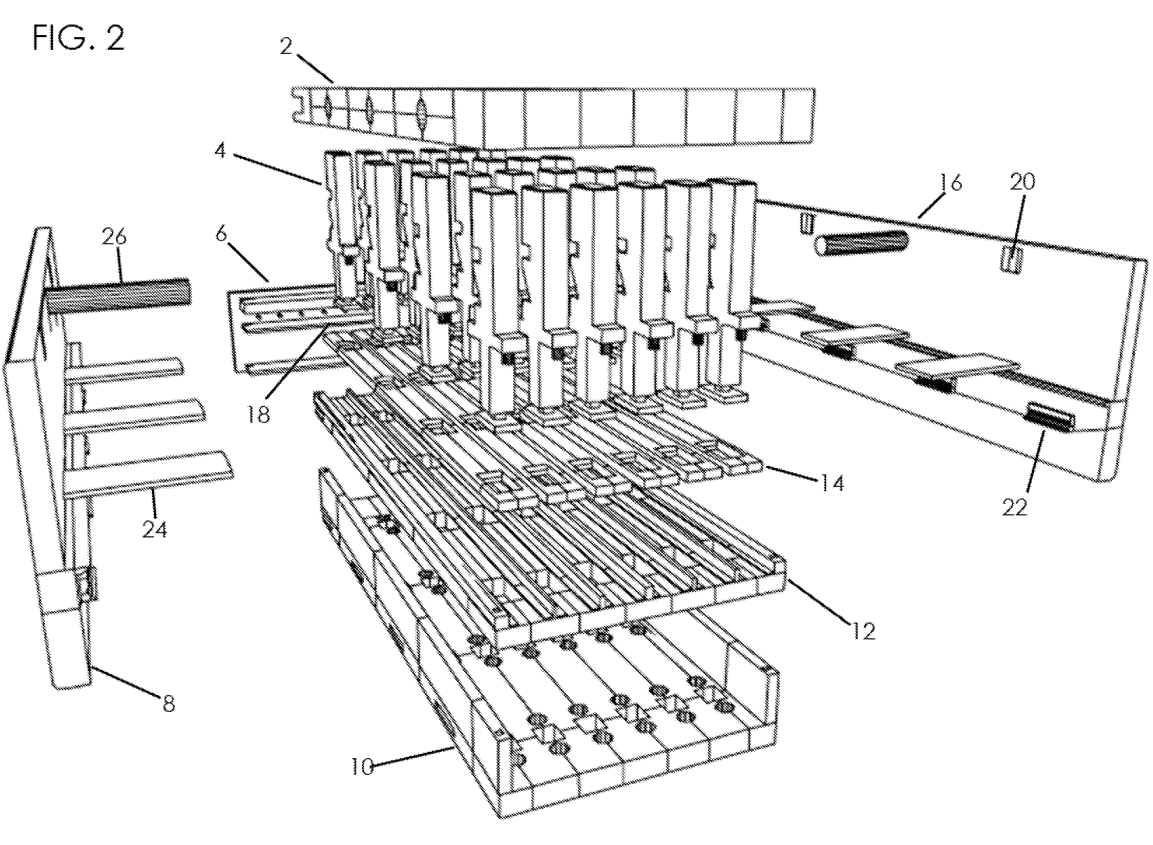

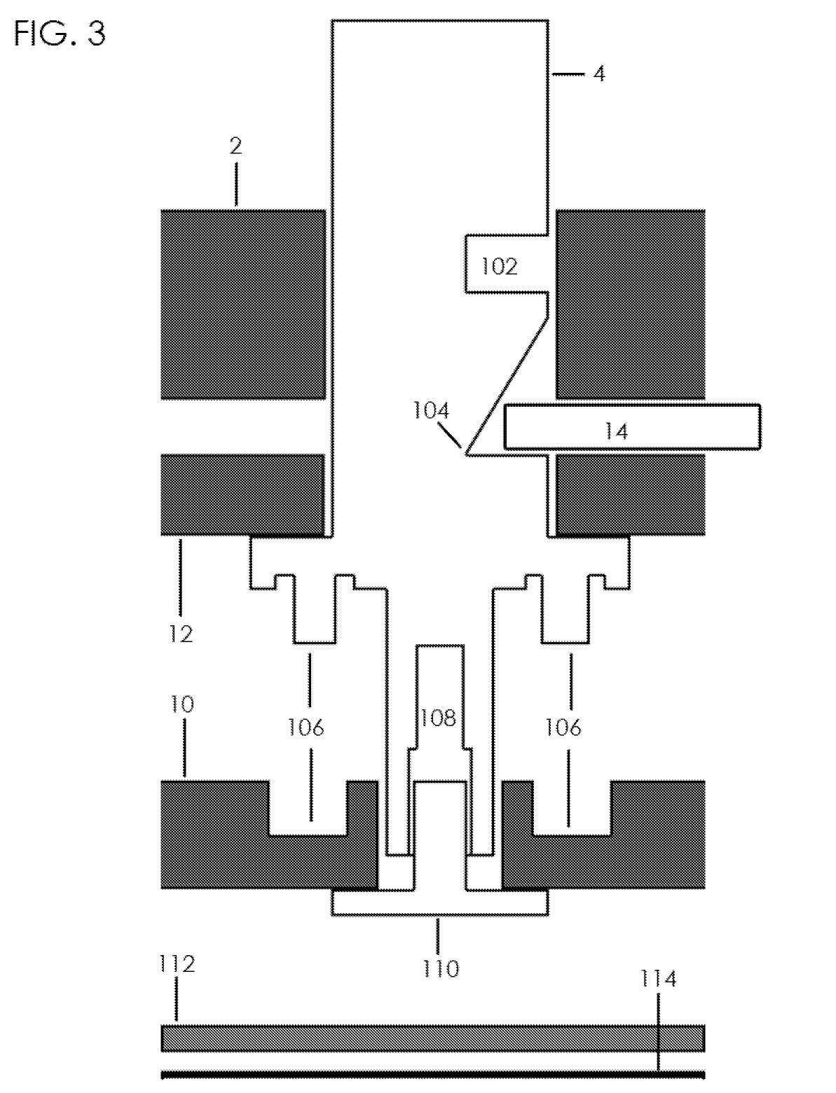

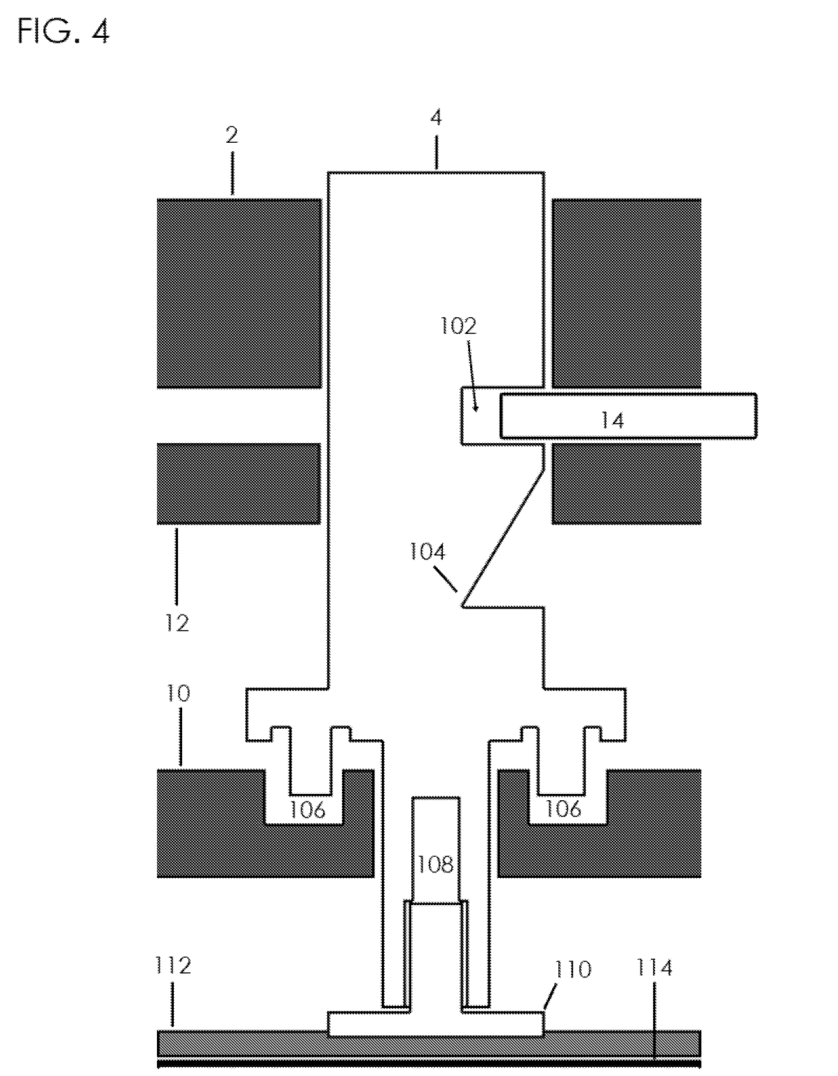

FIG. 2 is an exploded view of FIG. 1. In this envisioned embodiment, the triggers (2) are encompassed by a main shell consisting of a top plate (2), mid plate (12), and a bottom plate (10). The mid plate (12) contains grooves for slide/catch plates (14) which are spring loaded (18) against the back plate (6). The slide/catch plates (14) allow the interaction between the triggers (4) in each string column of triggers, releasing triggers (4) in their compressed state (FIG. 4) when triggers in their uncompressed state (FIG. 3) are activated. Mounting plates (8,16) are attached to the main shell via two tension springs secured to catches (20) in both mounting plates (8,16), connected through holes in the top plate (2). Guide rods (26) and guide plates (24) keep the mounting plates aligned correctly to the main shell when attaching to the instrument neck. The guide rods (26) pass through holes in the top plate (2). The guide plates (24) pass through holes in the bottom plate (10). Ridges (22) on the mounting plates (8,16) rest atop the neck of the instrument, allowing the mounting plates (8,16) to apply pressure to the side of the neck in order to keep the device attached to the neck. The distance between the ridges (22) and the bottom plate (10), create the Angled Mounting System, which allows for the triggers (4) to maintain the proper distance for depression and release of the strings. It is also possible to add an/attachment(s) to the mounting plates (8,16) that would apply pressure to the bottom of the neck of the instrument and aid in keeping the device firmly in place.

FIG. 3 is a cross sectional view focusing on an envisioned embodiment of a triggering mechanism in an uncompressed state. The trigger (4) is encompassed by a main shell consisting of a top plate (2), mid plate (12), and a bottom plate (10). A spring loaded slide/catch plate (14) rests in the space between the top plate (2) and the mid plate (12). Springs located in the space (106) keep the trigger in the uncompressed state. The slide/catch plate (14) is spring loaded causing force in the left direction of the illustration. In the uncompressed state, the trigger tip (110) rests below the bottom plate (10) and hovers above the instrument string (112) and neck (114). The trigger tip (110) is attached to the trigger (4) by a compression spring inside a space (108) of the trigger (4). When downward pressure is applied to the top of the trigger (4), the angled notch (104) in the trigger (4) pushes the slide/catch plate (14) to the right thus releasing any other compressed trigger (FIG. 4) in that particular string column of triggers into their uncompressed state. When further downward pressure is applied to the trigger (4), the slide/catch plate (14) pushes back to the left and into the catch notch (102) of the trigger (4). Holding the trigger now in a compressed state (FIG. 4).

FIG. 4 is a cross sectional view focusing on an envisioned embodiment of a triggering mechanism in a compressed state. In this state, the trigger tip (110) is pressing the instrument string (112) against the instrument neck (114). The trigger tip (110) maintains pressure on the instrument string (112) due to the force of the compressed compression spring inside a space (108) of the trigger (4). When a trigger in the uncompressed state (FIG. 3) in the same string column of triggers has downward pressure applied to it causing the slide/catch plate (14) to move right in the illustration, this compressed trigger will release back to the uncompressed state (FIG. 3) due to the force of the compressed compression springs located in the space (106).

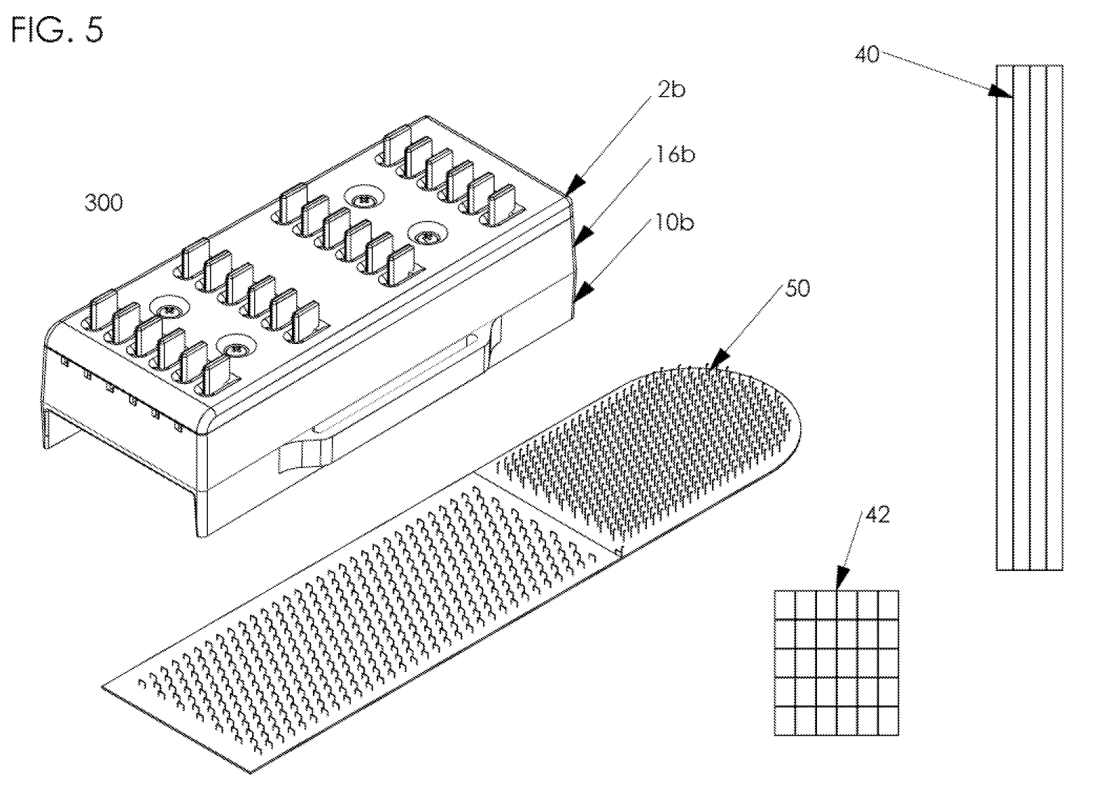

Another envisioned embodiment of the invention keeps all details of (FIG. 3) and (FIG. 4) the same, with the exception of using compressible pads (FIG. 5)(42) at the trigger tips (110) instead of, or in addition to, the adjustable tip (110), spring cavity (108), model, to allow for the variance in string (112) thickness.

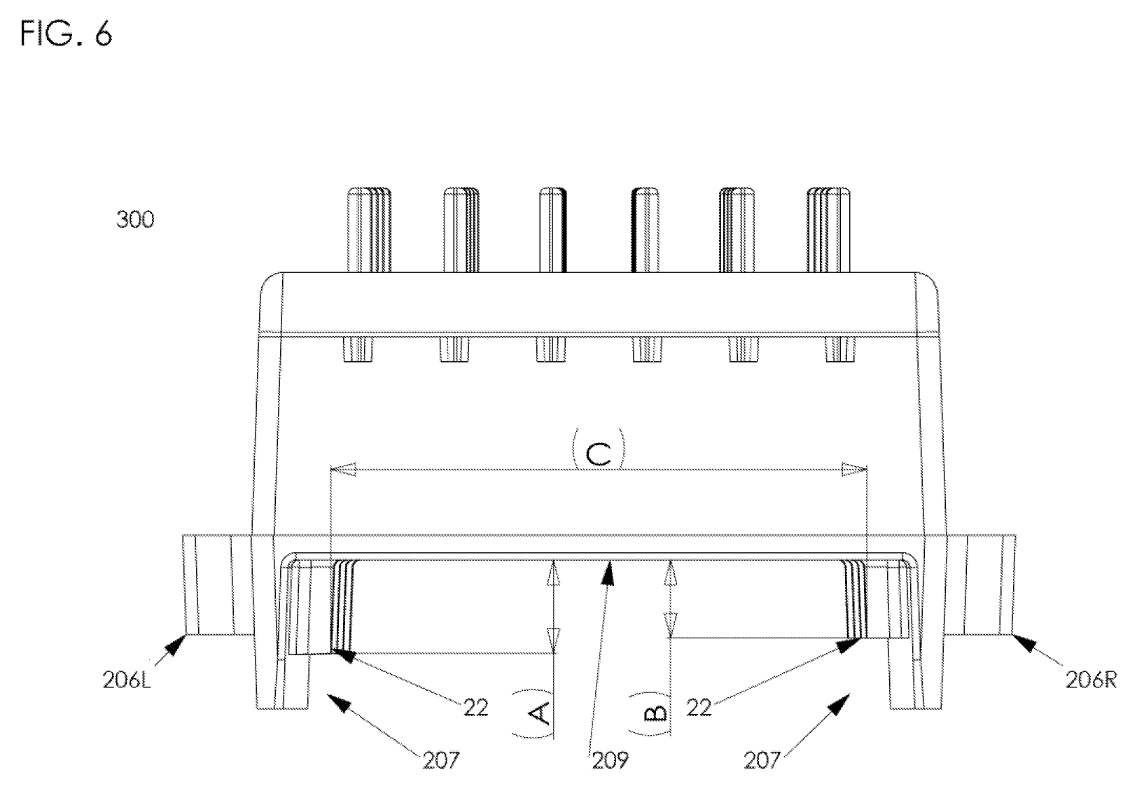

FIG. 5 illustrates another envisioned embodiment of the invention for a six string guitar spanning four frets. In this embodiment, the device (300) consists of a Top Plate (2b), Mid Plate (16b) and a Bottom/Mount Plate (10b) and utilizes adhesive mounting pads (40) [(40) Illustrates four pad strips] and a Velcro strap (50) to attach the device to the neck of the guitar. The mounting pads (40) vary in thickness and compression rate to allow the device to attach securely to the neck of a guitar as detailed in (FIG. 6). In addition, trigger pads (42) [(42) Illustrates 30 kiss cut trigger pads] may also be used to adjust the space between the trigger tips (FIG. 4)(110) and the neck of the instrument (FIG. 4)(114).

FIG. 6 is a front view of the device (300) focusing on an envisioned embodiment of a mounting mechanism utilizing adhesive pads (FIG. 5)(40) and a Velcro strap (FIG. 5)(50). The Velcro strap (FIG. 5)(50) will attach firmly to one of the wings (206R), and then, while attached to the neck of a guitar, double back upon itself through the other wing (206L) to securely fasten it. Mounting pads (FIG. 5)(40) will be attached to the face(s) (207) to accommodate for variances in neck widths, thus allowing the creation of one device that will work on different types and styles of guitars. The mounting ledges (22) have been designed so that the device will mount to the neck of the instrument at a very small angle. This angle is caused by the variance in height between the underside of the ledge (22) [The side that comes into contact with the neck of the instrument] and the underside (209) of the Bottom/Mount Plate (FIG. 5)(10b). These differing heights are represented by the distances (A) and (B) and result in the angle (Theta) calculated by: (Theta)=arctan((A−B)/C). This angle (Theta) was derived from the plane that runs tangent to the tops of the strings across the neck on the instrument, taking into account the average thickness a string could be at each position to get an average height. What this Angled Mounting System ultimately allows for is the creation of a device that, once mounted to the neck of the instrument, will have the same average distance between the tips of the triggers to the strings across the span of the instrument. This allows for the creation of one length of trigger for any string thickness. Making the device capable of functioning on many different types of instruments with variable string thicknesses through the application of pads (FIG. 5) (42) at the trigger tips, and allowing for mass production of one device that will fit and function on the majority of Instruments it was designed for. In this example, a six string Guitar.

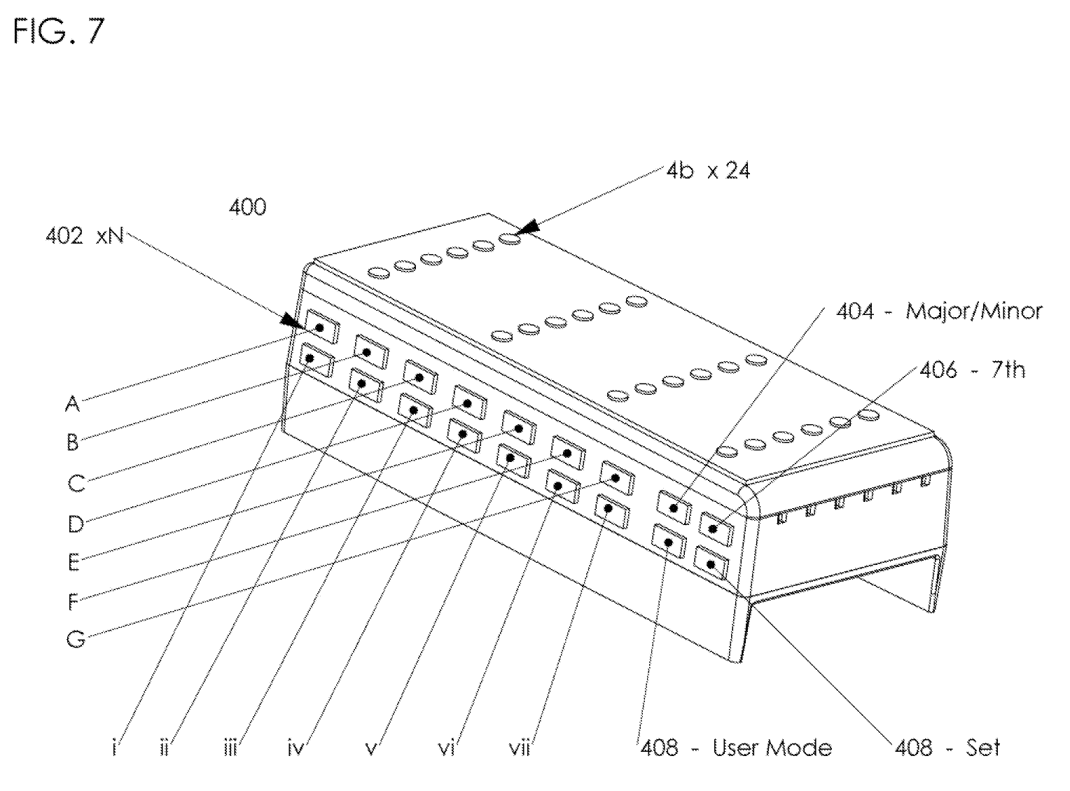

FIG. 7 illustrates another envisioned embodiment of the invention for a six string guitar spanning four frets. In this embodiment, the device (400) consists of electrical triggers (4b) that are used to toggle the depression of the strings against the neck of the instrument. These triggers could be touch sensitive, pressure sensitive, or any other type of toggling/switching electrical device. Buttons (402) arranged on the side of the device facing the performer allow the performer to automatically engage or disengage collections of triggers (4b). An envisioned embodiment of the buttons (402) would be seven buttons corresponding to the seven notes of Western Music (A,B,C,D,E,F,G). And under those seven notes, the seven degrees of the Western Music Scale (I, ii, iii, iv, v, vi, vii). Allowing the performer to set the Key Chord and then move around in that Key. Also envisioned would be a switch (404) to make the Key Major or Minor, a switch (406) to add or remove the 7^{th}, and user switches (408) so that the performer can program their own sets of triggers.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A multiple fret variable string capotasto, comprising: a plurality of triggers arranged to span multiple frets for separate strings of a stringed instrument.

2. The multiple fret variable string capotasto of claim 1, the plurality of triggers being adjustable.

3. The multiple fret variable string capotasto of claim 1, the plurality of triggers being arranged into a set of lines, each of the set of lines corresponding to a different one of the separate strings on the stringed instrument.

4. The multiple fret variable string capotasto of claim 1, the set of lines each comprising at least one trigger for each of the multiple frets

5. The multiple fret variable string capotasto of claim 1, the plurality of triggers being arranged so that each of the separate strings has at least one separate trigger for each of the multiple frets.

6. The multiple fret variable string capotasto of claim 1, the triggers being adjustable.

7. The multiple fret variable string capotasto of claim 1, the adjustability of the triggers being capable of accommodating variance in thickness or position of any of the separate strings.

8. The multiple fret variable string capotasto of claim 1, further comprising a mounting mechanism allowing for one device to function on instruments with similar but not equal neck widths and string spacing.

9. The multiple fret variable string capotasto of claim 8, the mounting mechanism implementing an Angled Mounting System.

10. The multiple fret variable string capotasto of claim 1, the plurality of triggers implemented to press and release the strings of the instrument.

11. The multiple fret variable string capotasto of claim 1, the plurality of triggers implemented to face a user on the side of the device.

12. A multiple fret variable string capotasto, comprising:
a plurality of adjustable triggers arranged to span multiple frets for separate strings of a stringed instrument; and
the plurality of triggers being arranged into a set of lines, each of the set of lines corresponding to a different one of the separate strings on the stringed instrument.

13. The multiple fret variable string capotasto of claim 12, the set of lines each comprising at least one trigger for each of the multiple frets

14. The multiple fret variable string capotasto of claim 12, the plurality of triggers being arranged so that each of the separate strings has at least one separate trigger for each of the multiple frets.

15. The multiple fret variable string capotasto of claim 12, the triggers being adjustable.

16. The multiple fret variable string capotasto of claim 12, the adjustability of the triggers being capable of accommodating variance in thickness or position of any of the separate strings.

17. The multiple fret variable string capotasto of claim 12, further comprising a mounting mechanism allowing for one device to function on instruments with similar but not equal neck widths and string spacing.

18. The multiple fret variable string capotasto of claim 12, the mounting mechanism implementing an Angled Mounting System.

19. The multiple fret variable string capotasto of claim 12, the plurality of triggers implemented to press and release the strings of the instrument.

20. The multiple fret variable string capotasto of claim 12, the plurality of triggers implemented to face a user on the side of the device.
